(19) United States
(12) Patent Application Publication
(10) Pub. No.: US 2003/0068130 A1
(43) Pub. Date: Apr. 10, 2003

(54) Dynamic gain-equalizing filter based on polymer optical waveguide gratings

(75) Inventor: Renyuan Gao, Strafford, PA (US)

Correspondence Address: Finnegan, Henderson, Farabow,, Garrett & Dunner, L.L.P., 1300 I Street, N.W., Washington, DC, 20005-3315, US

(73) Assignee: Photon-X, Inc.

(21) Appl. No.: 10/266,641

(22) Filed: Oct. 9, 2002

Related U.S. Application Data
(60) Provisional application No. 60/327,872, filed on Oct. 9, 2001.

(51) Int. Cl. G02B 6/34; G02B 6/26

(52) U.S. Cl. 385/37; 385/143; 385/27

(57) ABSTRACT

A reconfigurable optical filter includes a polymer waveguide core, at least one optical grating formed within the waveguide core, waveguide cladding surrounding the waveguide core, and one or more temperature control elements capable of changing the temperature of the optical gratings. Changing the temperature of the gratings adjust the attenuation spectrum of the filter. A control system may be used to adjust the attenuation spectrum of the filter to achieve a desired output, which may include flattening the non-uniform gain of rare-earth optical amplifiers.

### CROSS REFERENCE TO RELATED APPLICATION

Applicants claim the benefit under 35 U.S.C. §119(e) based on prior-filed, copending provisional patent application No. 60/327,872 filed Oct. 9, 2001, which is relied on and incorporated herein by reference.

### DESCRIPTION OF THE INVENTION

1. Field of the Invention

This invention relates to optical filters, and more particularly, to dynamic gain-equalizing filters using polymer optical waveguide gratings.

2. Background of the Invention

Modern telecommunications networks increasingly need integrated and re-configurable optical signal regeneration and amplification devices. An optical amplifier amplifies an optical signal directly in the optical domain without converting the signal into an electrical signal. In modern dense wavelength division multiplexed (DWDM) systems, multiple optical signal channels with different wavelengths are transmitted and amplified simultaneously. Due primarily to losses from fiber attenuation, optical signals must be amplified by optical amplifiers every 50-100 kilometers. It is desirable that the optical amplifiers amplify the signal equally at all wavelengths. The inherently non-uniform gain of most optical amplifiers, however, causes signal channels at different wavelengths to be amplified by different amounts. This non-uniform gain across the transmission spectrum results in signal noise and decreased system performance.

There have been efforts to overcome the effects of the non-uniform gain of known optical amplifiers by combining optical filters with optical amplifiers to equalize the amplifier gain spectrum. These gain-equalizing filters are generally static and have a predefined attenuation spectrum selected to compensate or flatten the non-uniform amplification spectrum of a particular type of optical amplifier. Due to the increasing need for dynamic reconfiguration and signal add/drop in optical networks, however, static gain-equalizing filters are no longer sufficient for stabilizing and equalizing optical channel gains. Changes in the number or type of signal channels passing through an amplifier causes the gain spectrum of the amplifier to vary in time. It is therefore desirable to have a dynamically reconfigurable optical amplifier gain-equalizing filter capable of flattening the gain spectrum of a signal despite changes in the input signal spectrum. Furthermore, with such a device, a single reconfigurable optical amplifier could be used in a variety of applications regardless of the type of signal the filter must process.

Though various designs and methods have been utilized in attempts to provide a dynamic gain-equalizing filter that avoids the problems of static filters discussed above, such devices and methods suffer from disadvantages. One known method changes the attenuation spectrum of the filter by applying heat to optical gratings making up the optical filter. The change in temperature alters the configuration of the gratings, resulting in a shift of the attenuation spectrum. However, these filters use silica or glass materials that respond poorly to the application of heat. Large changes in the temperature are required to achieve small shifts in the attenuation spectrum of the filters. Because the materials and other FINNEGAN components of the filter can be adversely affected by high operating temperatures, the range of adjustment of the attenuation spectrum of the filters is severely limited. Additionally, the high temperature ranges required to change the attenuation spectrum of the known devices require large amounts of energy, while the time required to change the temperature over such broad ranges leads to slow response times. Hence, there is a need for a reliable, high performance, low-cost dynamic gain equalization filter having an attenuation spectrum that can be easily tuned or reconfigured over a broad range of wavelengths.

### SUMMARY OF THE INVENTION

In accordance with the invention, there is provided a reconfigurable optical filter comprising a waveguide core comprised of polymer material; a waveguide cladding surrounding the waveguide core; at least one optical grating formed within the waveguide core; and at least one temperature control element capable of changing a temperature of the at least one optical grating.

Also in accordance with the invention, there is provided a method of fabricating a reconfigurable optical filter comprising providing a waveguide core comprised of polymer material; providing at least one optical grating formed within the waveguide core; providing a waveguide cladding surrounding the waveguide core; and forming at least one temperature control element capable of changing a temperature of the at least one optical grating.

Further in accordance with the invention, there is provided a method of fabricating a reconfigurable optical filter comprising forming a first cladding layer comprised of polymer on a substrate; forming a channel in the first cladding layer; forming a waveguide core in the channel, wherein the waveguide core is comprised of polymer; forming one or more optical gratings within the waveguide core; forming a second cladding layer comprised of polymer over the waveguide core; and forming at least one temperature control element capable of changing the temperature of at least a portion of one of the optical gratings.

Further in accordance with the invention, there is provided a method of filtering an optical signal comprising providing a waveguide core comprised of polymer material; providing at least one optical grating formed within the waveguide core; providing a waveguide cladding surrounding the waveguide core; providing at least one temperature control element capable of changing a temperature of the at least one optical grating; and changing a temperature of at least one of the plurality of optical gratings.

Additionally, in accordance with the invention, there is provided a method of fabricating a reconfigurable optical filter comprising forming a first cladding layer comprised of polymer on a substrate; forming a layer of waveguide core material on the first cladding layer, wherein the waveguide core is comprised of polymer; patterning the layer of waveguide core material to form a waveguide core; forming one or more optical gratings within the waveguide core; forming a second cladding layer comprised of polymer over the waveguide core; and forming at least one temperature control element capable of changing the temperature of at least a portion of one of the optical gratings.

Additional features and advantages of the invention will be set forth in part in the description which follows, and in part will be obvious from the description, or may be learned by practice of the invention.

The accompanying drawings, which are incorporated in and constitute a part of this specification, illustrate embodiments of the invention and together with the description, serve to explain the principles of the invention.

It is to be understood that both the foregoing general description and the following detailed description are exemplary and explanatory only and are not restrictive of the invention, as claimed.

### BRIEF DESCRIPTION OF THE DRAWINGS

FIG. 1 is a longitudinal cross sectional view of a dynamic gain-equalizing filter according to the present invention.

FIGS. 2(a)-2(c) are longitudinal cross sectional views of gratings in accordance with the present invention.

FIGS. 3(a)-3(g) are cross-sectional views showing the steps of a first method of manufacturing a gain-equalizing filter consistent with the present invention.

FIGS. 4(a)-4(g) are cross-sectional views showing the steps a second method of manufacturing a gain-equalizing filter consistent with the present invention.

FIG. 5 is a diagram showing waveguide mode coupling according to the present invention.

FIG. 6 is a diagram showing an exemplary relationship between wave vectors in accordance with the present invention.

FIG. 7 is a graph of attenuation spectra of gratings alone and in combination in accordance with the present invention.

FIG. 8 is a graph of an attenuation spectrum of a grating at three temperatures according to the present invention.

FIG. 9 is a is a longitudinal cross sectional view of a dynamic gain-equalizing filter according to the present invention.

FIG. 10 is a graph of the gain and attenuation of an exemplary input, attenuation spectrum, and output according to the present invention.

### DESCRIPTION OF THE EMBODIMENTS

Reference will now be made in detail to the present embodiments of the invention, examples of which are illustrated in the accompanying drawings. Wherever possible, the same reference numbers will be used throughout the drawings to refer to the same or like parts.

The present invention relates to optical filters, and more particularly, to dynamic gain-equalizing filters using polymer optical waveguide gratings. A reconfigurable optical filter includes a polymer waveguide core, at least one optical grating formed within the waveguide core, waveguide cladding surrounding the waveguide core, and one or more temperature control elements capable of changing the temperature of the optical gratings. Changing the temperature of the gratings adjusts the attenuation spectrum of the filter. A control system may be used to adjust the attenuation spectrum of the filter to achieve a desired output, which may include flattening the non-uniform gain of rare-earth type optical amplifiers.

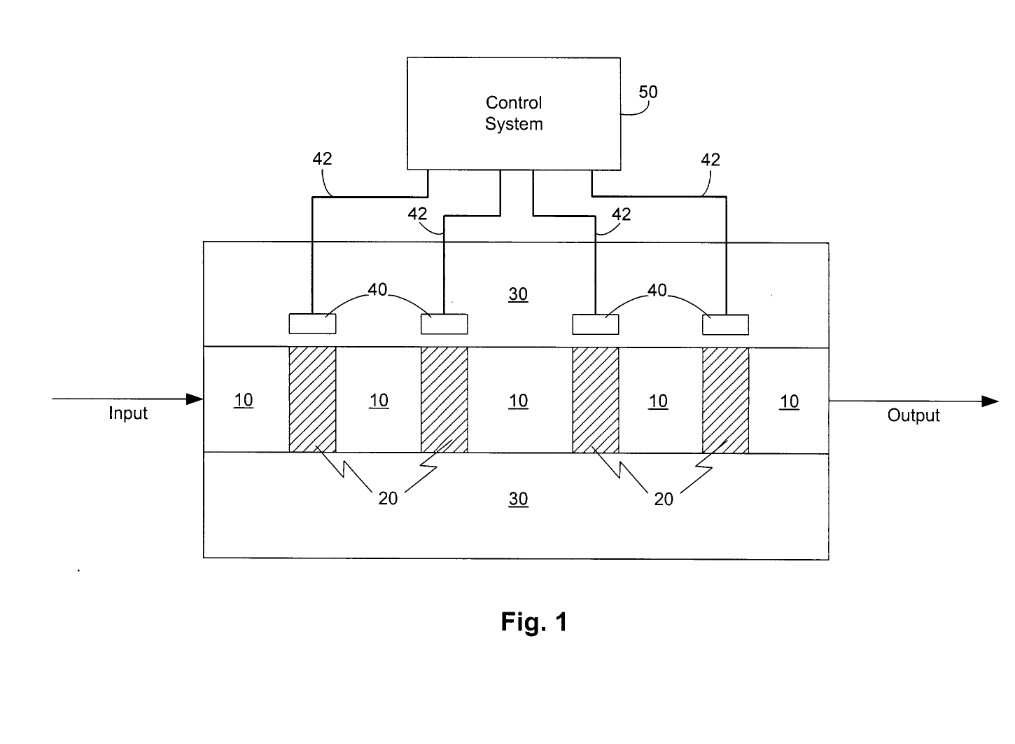

FIG. 1 is an embodiment of a dynamic gain-equalizing filter according to the present invention. A polymer-based waveguide cladding 30 surrounds a polymer-based waveguide core 10. A plurality of optical gratings 20 are formed within the waveguide core 10. Temperature control elements 40 near the optical gratings 20 are electrically connected to a control system 50 which supplies electrical current for controlling the temperature of the temperature control elements 40. The device is adapted to be coupled to input and output fibers or directly to other optical devices. The invention is further described below.

The waveguide core 10 is comprised of polymer-based material such as, for example, halogenated polymers, fluoropolymers and perfluoro polymers. Reference is made to U.S. Pat. No. 6,292,292 to Garito et al., and to U.S. Patent Application Serial No. 60/314,902, the entire contents of which are hereby incorporated by reference, for a detailed description of such halogenated polymers, fluoropolymers and perfluoro polymers. The waveguide core may be a fiber or planar waveguide.

The cladding material 30 may include any material suitable for waveguide cladding, but is preferably comprised of polymer-based material such as, for example, halogenated polymers fluoropolymers and perfluoro polymers disclosed in U.S. Pat. No. 6,292,292 to Garito et al and to U.S. Patent Application Serial No. 60/314,902. Generally, the cladding material 30 has an index of refraction that is 100.3%-103% of the value of the index of refraction of the waveguide core 10. One or more temperature control elements 40 are formed in the cladding 30 near one or more of the gratings 20. Alternatively, though not shown in FIG. 1, the temperature control elements 40 can be formed on the outside surface of the cladding 30. The temperature control elements 40 are preferably resistive heating elements capable of locally applying heat to the gratings 20 or portions thereof when electrical current is supplied by the control system 50. The temperature control elements 40 may change the temperature of an entire grating 20, or may be capable of controlling the temperature of individual grating layers within a grating 20.

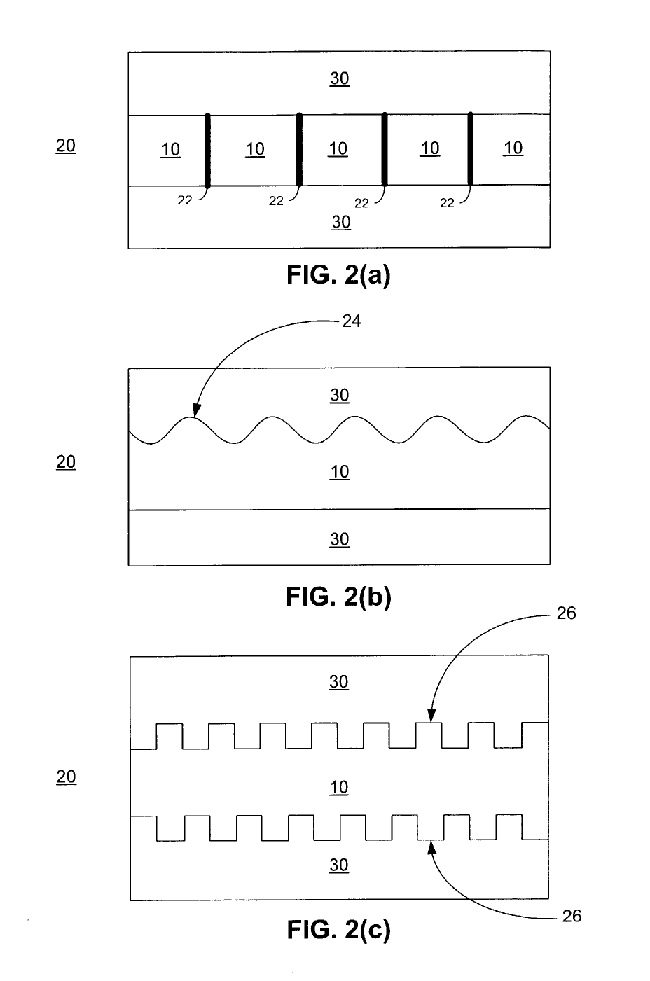

The gratings are structures or variations of the waveguide core that result in periodic variations of the index of refraction along the length of the waveguide core. The gratings scatter light in a way similar to diffraction gratings and transmit or reflect certain wavelengths selectively, depending on the configuration of the gratings. FIG. 2(a) shows a grating 20 in cross-section, according to the present invention, comprised of grating layers 22 that have an index of refraction that differs from the surrounding waveguide core 10. It is desirable that the index of refraction of the grating layers 22 be 0.01%-1% variations from the index of refraction of the adjacent waveguide core 10. The grating layers 22 are generally comprised of the same polymer material as the surrounding waveguide core, but have been altered by exposure to UV light to change the index of refraction. Alternatively, the gratings of the present invention can comprise corrugations of the vertical or horizontal dimensions of the waveguide core. FIG. 2(b) is a side view longitudinal cross-section of a grating according to the present invention comprising corrugations 24 of the vertical dimensions of the waveguide core 10. FIG. 2(c) is a top view longitudinal cross-section of a grating 20 according to the present invention comprising corrugations 26 of the horizontal dimensions of the waveguide core 10. In both FIGS. 2(b) and 2(c), the corrugations 24, 26 of the waveguide core surface are generally 0.1-10% of the waveguide core thickness. The corrugations 24, 26 of the surface of the waveguide core 10 give the gratings shown in FIGS. 2(b) and 2(c) an effective index of refraction that depends on the dimensions of the corrugations 24, 26. Thus the gratings of FIG. 2(a), 2(b), or 2(c) all have an effective index of refraction that differs from the effective index of refraction of the adjacent waveguide core 10.

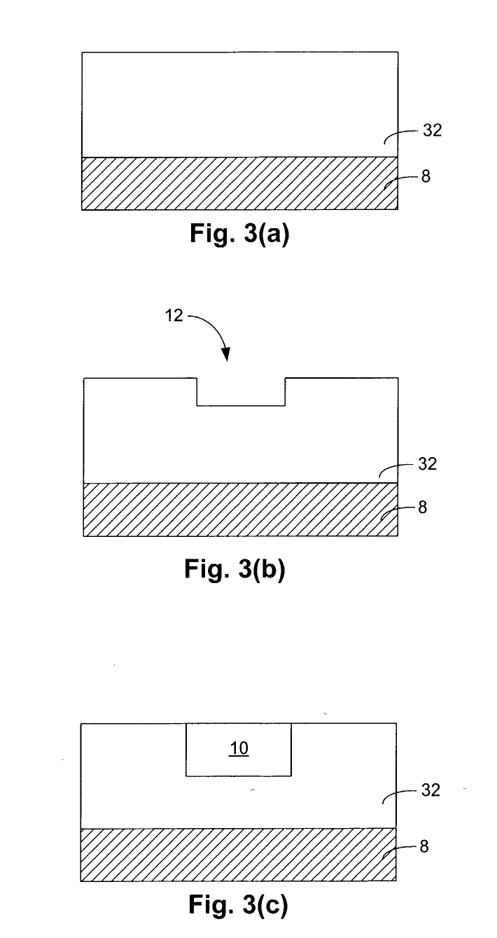

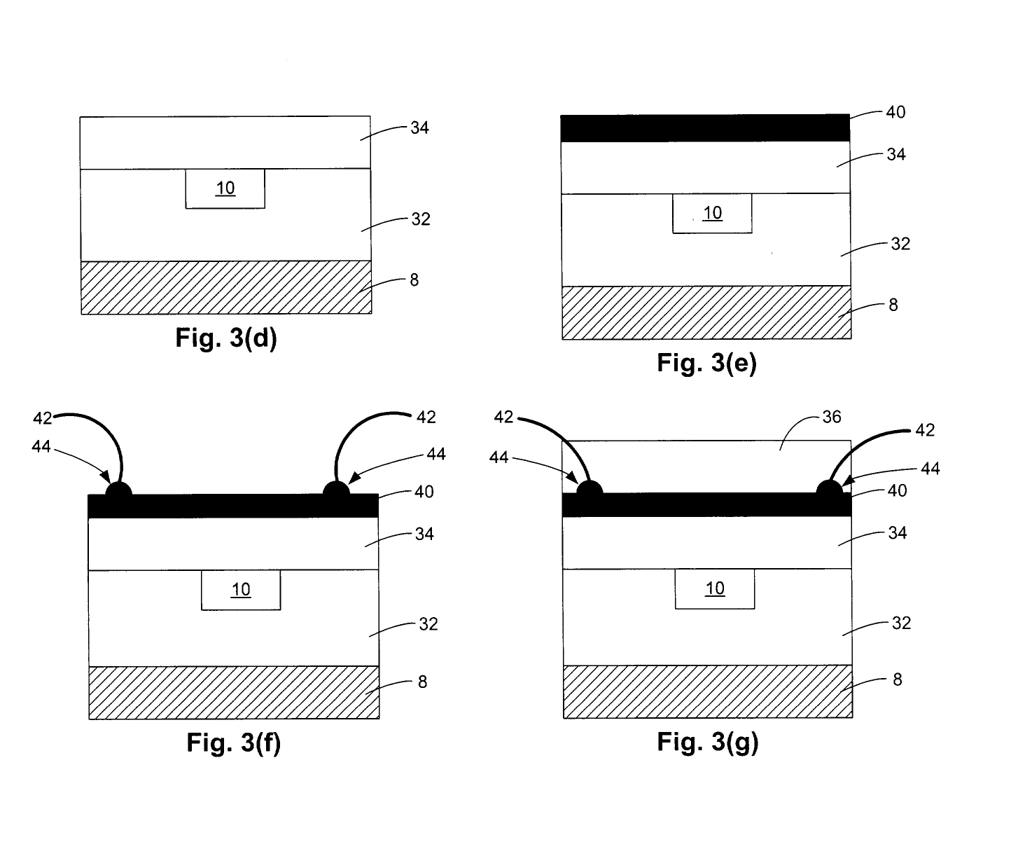

FIGS. 3(a)-3(g), each of which represents a cross section, illustrate the steps of manufacturing an embodiment of a tunable waveguide laser according to the present invention. First, as shown in FIG. 3(a), a first layer 32 of cladding is formed on a silicon or polymer substrate 8. The first cladding layer 32 is formed by dissolving a polymer material such as Hyflon®, in a known solvent, such as Fluorinert® FC-40, and spin coating the material onto the substrate to form the structure shown in FIG. 3(a). As shown in FIG. 3(b), a channel 12 is then formed in the first cladding layer 32 using a known process such as reactive ion dry etching or any other method known to those skilled in the art. Next, a polymer waveguide core 10 material is dissolved in a known solvent, such as Fluorinert® FC40®, and applied using a spin coat method. Some of the waveguide core 10 material is then removed using reactive etching, such that the waveguide core 10 material is disposed only in the channel 12 as shown in FIG. 3(c). Next, gratings are formed within a portion of the waveguide core material using a known method such as, for example, applying radiation to areas of the waveguide in which the gratings are to be formed. The process is similar to the process of forming gratings in silica fibers disclosed in Hecht, Understanding Fiber Optics, Third Edition (1999), p.131. Then, as shown in FIG. 3(d), a second layer 34 of cladding material is added using the same process used to form the first cladding layer 32. FIG. 3(e) shows the addition of temperature control elements 40. The temperature control elements 40 may be formed by applying a prefabricated metal film or depositing a layer of resistive metal by a known process such as, for example, a vapor deposition technique. The temperature control elements 40 are patterned so that they are positioned substantially over the gratings. Additionally, connectors for electrically connecting the heating elements to a power source, such as bonding pads or electrodes, may also be patterned into the temperature control elements 40. In FIG. 3(f), connection wires 42 have been electrically connected to the temperature control elements 40 by solder 44. Lastly, a third cladding layer 36 is formed using the same method used to form the first and second cladding layers 32, 34. The result, shown in FIG. 3(g), represents a cross section of a grating region of an embodiment of the present invention. Alternatively, the gratings shown in FIGS. 3(a)-3(g) may be replaced with gratings shown in FIG. 2(b) or 2(c) by selectively etching the waveguide cladding or the waveguide core to achieve the desired corrugations.

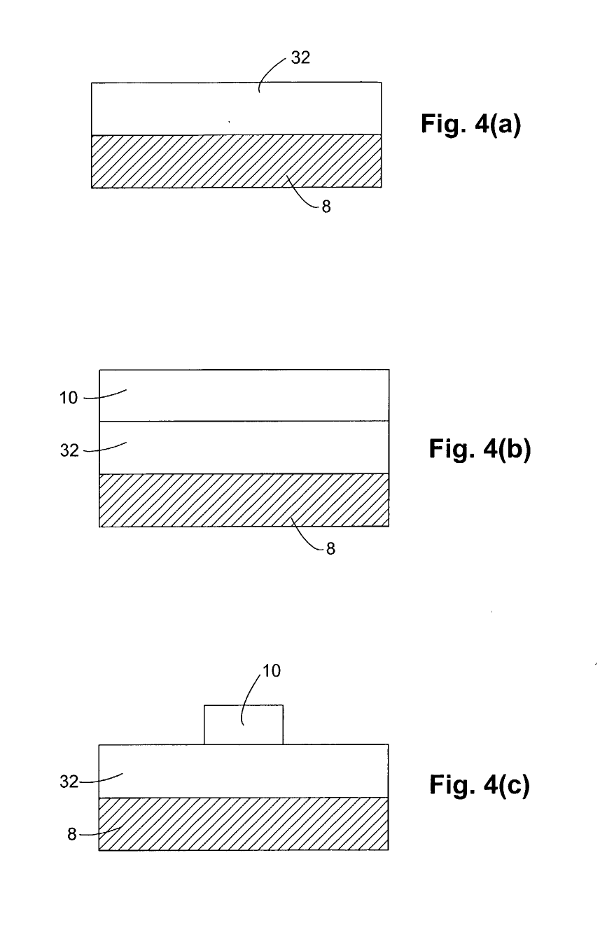

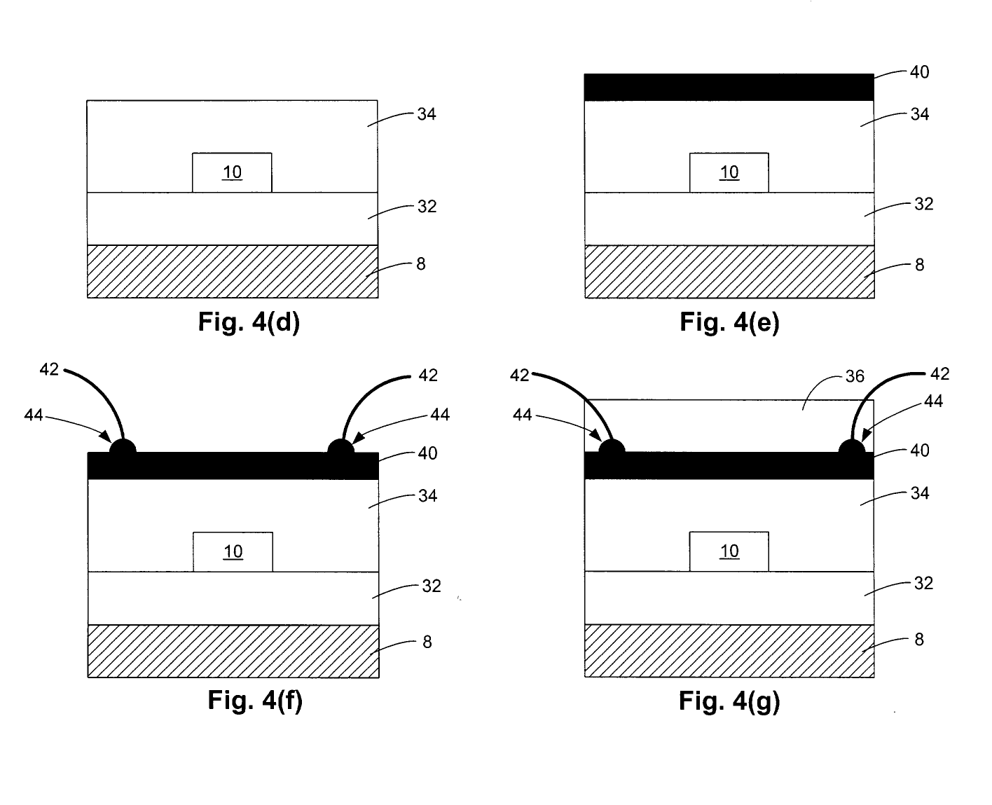

An alternative method of manufacturing an embodiment of a tunable waveguide grating according to the present invention is shown in FIGS. 4(a)-4(g), each of which represents a cross section. First, as shown in FIG. 4(a), a first layer 32 of cladding is formed on a silicon or polymer substrate 8. The first cladding layer 32 is formed by dissolving a polymer material such as Hyflon®, in a known solvent, such as Fluorinert® FC-40, and spin coating the material onto the substrate to form the structure shown in FIG. 4(a). Then, a polymer waveguide core 10 material is dissolved in a known solvent, such as Fluorinert® FC-40®, and applied using a spin coat method to achieve the structure shown in FIG. 4(b). The waveguide core 10 layer is then etched as shown in FIG. 4(c) using a known process such as reactive ion dry etching or any other method known to those skilled in the art. Either before or after the step of etching the waveguide core 10, gratings are formed within a portion of the waveguide core material 10 using the process described above with reference to FIGS. 3(c)-3(d). Then, as shown in FIG. 4(d), a second layer 34 of cladding material is added using the same process used to form the first cladding layer 32. FIG. 4(e) shows the addition of temperature control elements 40 using the same processes described in reference to FIG. 3(e). In FIG. 4(f), connection wires 42 have been electrically connected to the temperature control elements 40 by solder 44. Lastly, as shown in FIG. 4(g), a third cladding layer 36 is formed using the same method used to form the first and second cladding layers 32, 34.

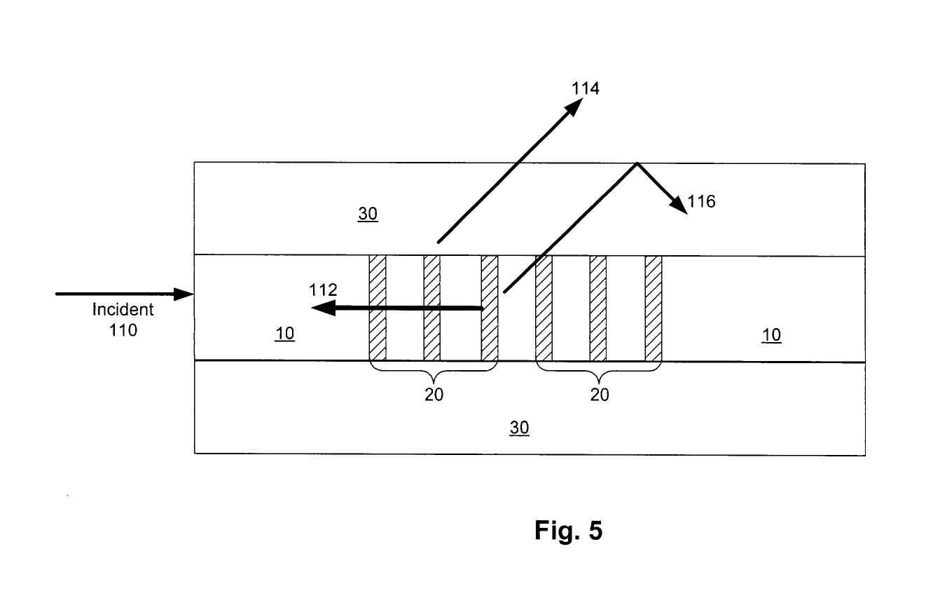

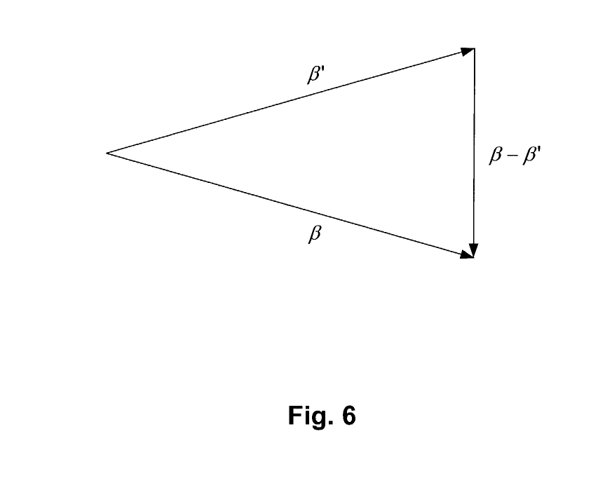

The use of optical gratings within fibers to filter signals is known. Gratings result in variations in the index of refraction along a length of fiber. The effect of light passing through a particular grating depends on the wavelength of the light. Referring to FIG. 5, gratings result in perturbations of the waveguide mode of light traveling through them, resulting in coupling of the incident waveguide mode 110 to backward traveling modes 112, cladding modes 116, or radiation modes 114. This coupling results in intensity attenuation of the forward traveling light at particular wavelengths. The attenuation spectra of the gratings is dependent on both the spacing between the gratings and the difference between the index of refraction of the grating and the index of refraction of the adjacent waveguide core. When an optical signal with wavelength λ is traveling inside the waveguide core with a wavevector β, mode coupling occurs when β′=(β−2π/Λ) where β′ is the wavevector of the perturbed, or scattered propagation mode and Λ is the grating period. In the context of the gain spectrum flattening filter of the present invention, the perturbed or scattered propagation mode is the forward propagating cladding mode. Furthermore, as shown in FIG. 6 and β-β′ is small compared to the wave vector β. Thus, by configuring gratings with a particular period and variation in the index of refraction, the attenuation spectrum of the grating can be chosen.

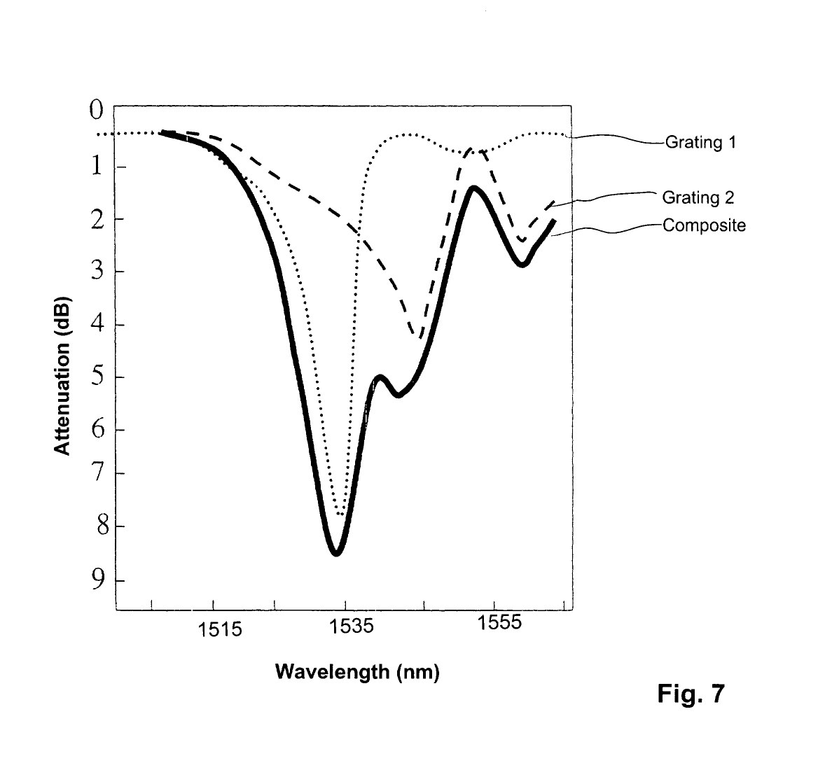

Referring to FIG. 7, several gratings with different configurations may be arranged in series to result in a composite attenuation spectrum. The graph shows an exemplary attenuation spectrum of grating 1 alone, the attenuation spectrum of grating 2 alone, and the composite spectrum of gratings 1 and 2. Thus, by combining gratings having different attenuation spectra, the composite attenuation spectrum can be selected.

In an aspect of the present invention, the composite attenuation spectrum of the gratings is initially selected to flatten the non-uniform gain of a typical input such as the output of a rare-earth type optical amplifier. This preselected attenuation spectrum is then dynamically tuned by manipulating the grating period and differences in indices of refraction of the gratings and surrounding waveguide core.

The gratings according to the present invention are comprised of polymers. Polymers have a high thermo-optical coefficient compared to other waveguide materials such as glass. This means that applying a given amount of heat to the polymer grating results in a larger change in the index of refraction compared to other materials such as glass. Further, polymers have a high thermal expansion coefficient such that when heat is applied to the polymer material it expands. Polymers also have relatively low thermal conductivity, such that a small amount of heat energy applied to a point results in efficient local heating around the application point. As a result, polymers are well suited for use in tuning the output of the dynamic gain-equalizing filter of the present invention because relatively small amounts of heat can be locally applied to significantly change the index of refraction and grating period.

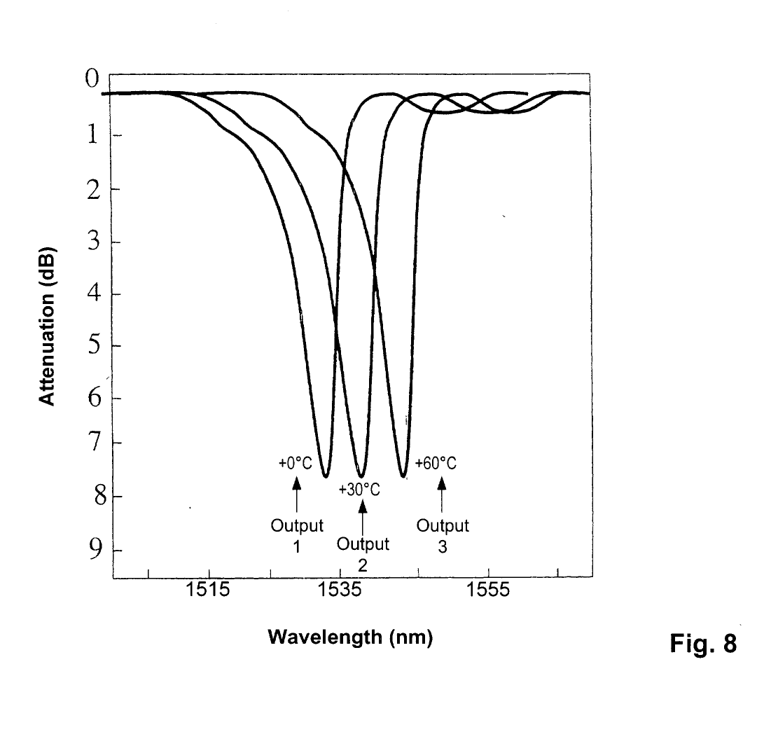

FIG. 8 is a graph of an exemplary attenuation spectrum of a grating at three different temperatures. Attenuation by the grating is centered around a peak wavelength that can be shifted by changing the temperature of the grating. Output 1 is the result of the waveguide laser, including the grating 20, operating at a first temperature denoted as +0° C. The temperature of the grating 20 is increased by 30° C. over the first temperature to achieve output 2. Output 3 is the result of increasing the temperature of the grating 20 by 60° C. over the first temperature. More generally, increasing the temperature of the grating by 1-100° C. may be accomplished by supplying one to several hundred milliwatts of energy to the temperature control elements. These temperature changes can shift the output attenuation spectrum of the grating by 10-20 nanometers. The output of the filter can be adjusted virtually in real time with response times on the order of 50 milliseconds.

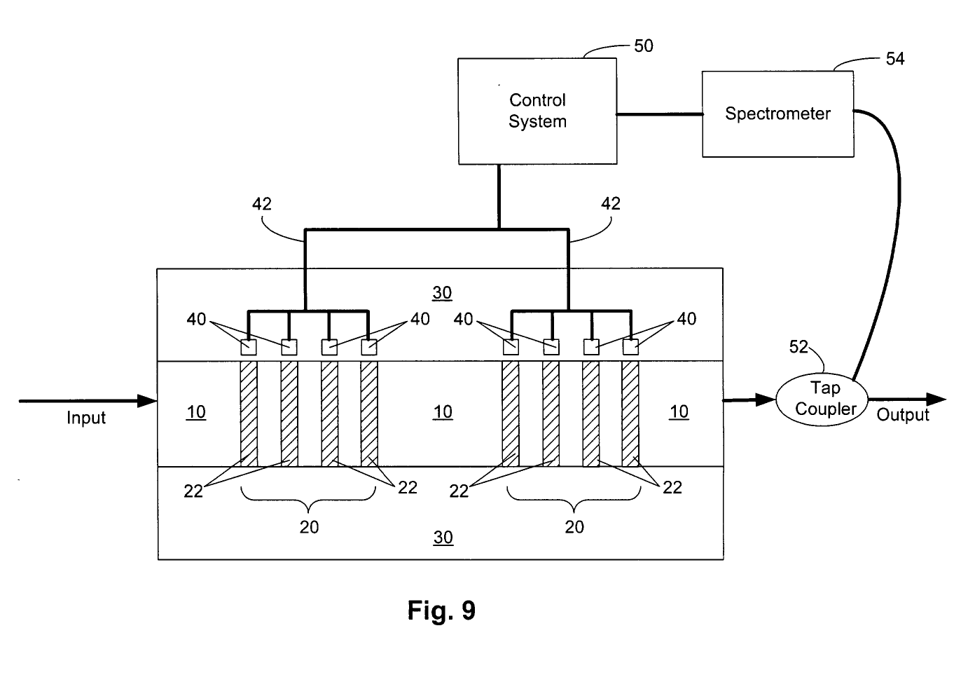

Operation of an embodiment of the dynamic gain-equalizing filter of the present invention is explained with reference to FIG. 9. The index of refraction of the gratings 20 and the period between them are chosen, at the time of fabrication, to attenuate a particular gain spectrum of an intended input signal. Generally this selection is based on equalizing the non-uniform gain of a typical rare-earth doped optical amplifier. In use, the chosen attenuation spectrum can be dynamically altered by changing the temperature of the gratings 20. The temperature of portions of each grating 20, such as each grating layer 22, may be independently controlled. Because of the properties of the polymers comprising the gratings 20, the application of heat changes both the index of refraction and the period between the grating layers 22 and the gratings 20. This results in a shift in the attenuation spectrum of the filter that results in a corresponding change in the output spectrum of the filter.

A control system 50 comprising a source of electrical current may be used to adjust the attenuation spectrum to achieve the desired output spectrum. The control system 50 is preferably microprocessor based and may include a memory and other operational circuitry. Preferably, heat is applied to the gratings 20 by resistive heating elements 40 that produce heat when electric current is supplied on connection wires 42. The output signal may be sampled using a tap coupler to supply a portion of the output signal to a spectrometer 54 or similar instrument to determine the output spectrum. The control system 50 receives data from the spectrometer 54 and adjusts the energy supplied to the temperature control elements 40 to achieve a desired output spectrum. Alternatively, the system may apply a predetermined amount of energy to the temperature control elements 40 to achieve a desired output spectrum. The amount of energy to achieve a given output is predetermined experimentally and then stored in the control system for later operation.

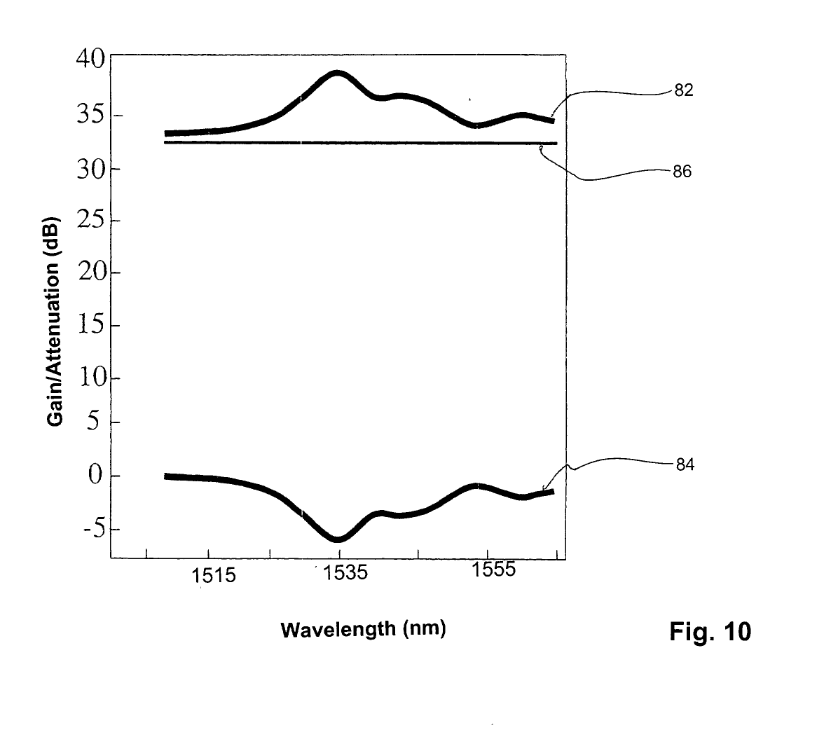

FIG. 10 is a graph of an exemplary output of a dynamic gain-equalizing filter according to the present invention. The graph shows an input gain spectrum 82 before the gain equalization filter, an attenuation spectrum 84 of the gain equalization filter, and a flattened output gain spectrum 86 of the gain equalization filter. Though not shown in FIG. 8, when the input spectrum changes, the attenuation spectrum of the filter can be altered by adjusting the temperature of the gratings. In this way, a uniform gain output or other desired output can be maintained.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A reconfigurable optical filter comprising:
a waveguide core comprised of polymer material;
a waveguide cladding surrounding the waveguide core;
at least one optical grating formed within the waveguide core; and
at least one temperature control element capable of changing a temperature of the at least one optical grating.

2. The reconfigurable optical filter of claim 1, wherein the polymer material of the waveguide core comprises a halogenated polymer.

3. The reconfigurable optical filter of claim 2, wherein the halogenated polymer is a fluoropolymer.

4. The reconfigurable optical filter of claim 1, wherein the waveguide cladding is comprised of polymer material.

5. The reconfigurable optical filter of claim 4, wherein the polymer material of the waveguide cladding comprises a halogenated polymer.

6. The reconfigurable optical filter of claim 5, wherein the halogenated polymer is a fluoropolymer.

7. The reconfigurable optical filter of claim 1, wherein the polymer material of the waveguide core comprises a perfluoro polymer.

8. The reconfigurable optical filter of claim 4, wherein the polymer material of the waveguide cladding comprises a perfluoro polymer.

9. The reconfigurable optical filter of claim 1, wherein the at least one temperature control element is disposed within the waveguide cladding.

10. The reconfigurable optical filter of claim 1, further comprising a system for controlling the temperature of the at least one temperature control element.

11. The reconfigurable optical filter of claim 10, further comprising at least a second temperature control element.

12. The reconfigurable optical filter of claim 11, wherein the system is capable of independently controlling each of the at least first and second temperature control elements.

13. The reconfigurable optical filter of claim 10, wherein the system is capable of comparing an actual output to a desired output and adjusting the temperature of the at least one temperature control element to achieve the desired output.

14. The reconfigurable optical filter of claim 1, wherein the waveguide core is a planar waveguide core.

15. The reconfigurable optical filter of claim 1, wherein the reconfigurable optical filter is disposed on a substrate.

16. The reconfigurable optical filter of claim 15, wherein the substrate is comprised of polymer material.

17. A method of fabricating a reconfigurable optical filter comprising:
providing a waveguide core comprised of polymer material;
providing at least one optical grating formed within the waveguide core;
providing a waveguide cladding surrounding the waveguide core; and
forming at least one temperature control element capable of changing a temperature of the at least one optical grating.

18. The method of fabricating a reconfigurable optical filter of claim 17, wherein the polymer material of the waveguide core comprises a halogenated polymer.

19. The method of fabricating a reconfigurable optical filter of claim 18, wherein the halogenated polymer is a fluoropolymer.

20. The method of fabricating a reconfigurable optical filter of claim 17, wherein the waveguide cladding is comprised of polymer material.

21. The method of fabricating a reconfigurable optical filter of claim 20, wherein the polymer material of the waveguide cladding comprises a halogenated polymer.

22. The method of fabricating a reconfigurable optical filter of claim 21, wherein the halogenated polymer is a fluoropolymer.

23. The method of fabricating a reconfigurable optical filter of claim 17, wherein the polymer material of the waveguide core comprises a perfluoro polymer.

24. The method of fabricating a reconfigurable optical filter of claim 17, wherein the polymer material of the waveguide cladding comprises a perfluoro polymer.

25. The method of fabricating a reconfigurable optical filter of claim 17, wherein the at least one temperature control element is formed within the waveguide cladding.

26. The method of fabricating a reconfigurable optical filter of claim 17, further comprising providing a system for controlling the temperature of the at least one temperature control elements.

27. The method of fabricating a reconfigurable optical filter of claim 26, further comprising providing at least a second temperature control element.

28. The method of fabricating a reconfigurable optical filter of claim 27, wherein the system is capable of independently controlling each of the at least first and second temperature control elements.

29. The method of fabricating a reconfigurable optical filter of claim 26, wherein the system compares an actual output to a desired output and adjusts the temperature of the at least one temperature control element to achieve the desired output.

30. The method of fabricating a reconfigurable optical filter of claim 17, wherein the waveguide core is a planar waveguide core.

31. The method of fabricating a reconfigurable optical filter of claim 17, wherein the waveguide core and the waveguide cladding are formed on a substrate.

32. The method of fabricating a reconfigurable optical filter of claim 31, wherein the substrate is comprised of polymer.

33. A method of fabricating a reconfigurable optical filter comprising:
forming a first cladding layer comprised of polymer on a substrate;
forming a channel in the first cladding layer;
forming a waveguide core in the channel, wherein the waveguide core is comprised of polymer;
forming one or more optical gratings within the waveguide core;
forming a second cladding layer comprised of polymer over the waveguide core; and
forming at least one temperature control element capable of changing the temperature of at least a portion of one of the optical gratings.

34. The method of fabricating a reconfigurable optical filter of claim 33, further comprising providing a system for controlling the temperature of the at least one temperature control element.

35. A method of filtering an optical signal comprising:
providing a waveguide core comprised of polymer material;
providing at least one optical grating formed within the waveguide core;
providing a waveguide cladding surrounding the waveguide core;
providing at least one temperature control element capable of changing a temperature of the at least one optical grating; and
changing a temperature of at the least one optical grating.

36. A method of fabricating a reconfigurable optical filter comprising:
forming a first cladding layer comprised of polymer on a substrate;
forming a layer of waveguide core material on the first cladding layer, wherein the waveguide core is comprised of polymer;
patterning the layer of waveguide core material to form a waveguide core;
forming one or more optical gratings within the waveguide core;
forming a second cladding layer comprised of polymer over the waveguide core; and
forming at least one temperature control element capable of changing the temperature of at least a portion of one of the optical gratings.

37. The method of fabricating a reconfigurable optical filter of claim 33, further comprising providing a system for controlling the temperature of the at least one temperature control element.
